(19) United States
(12) Patent Application Publication
(10) Pub. No.: US 2026/0364390 A1
(43) Pub. Date: Nov. 19, 2026

(54) MULTI-ZONE INTERFACE MODULE FOR FIRE SUPPRESSION SYSTEM

(71) Applicant: Tyco Fire Products LP, Cranston, RI (US)

(72) Inventors: Sean S. Troutt, Stephenson, MI (US); David Strobel, Marinette, WI (US); Luke Charles Giwojna, Coleman, WI (US); John J. Allen, Johnston, RI (US)

(73) Assignee: Tyco Fire Products LP, Cranston, RI (US)

(21) Appl. No.: 19/477,040

(22) PCT Filed: Jul. 11, 2024
(86) PCT No.: PCT/IB2024/056742

§ 371 Date: Oct. 20, 2025

Related U.S. Application Data
(60) Provisional application No. 63/513,750, filed on Jul. 14, 2023.

(51) Int. Cl. A62C 3/16; A62C 35/02; A62C 35/68; A62C 37/40

(52) U.S. Cl. CPC A62C 3/16; A62C 35/02; A62C 35/68; A62C 37/40

(57) ABSTRACT

A system comprising a fire suppression system configured to selectively provide a fire suppressant agent to a monitored area, and a zone module having one or more processors and a memory storing instructions that cause the one or more processors to perform operations. The operations comprise identifying one or more zones within the monitored area, receiving, from detectors, signals relating to one or more measured thermal characteristics associated with each of the one or more zones, and detecting, based on the signals, a potential thermal runaway event at a failure zone. The operations further comprise initiating a first control decision to expel the fire suppressant agent from a supply, and initiating, based on detecting the potential thermal runaway event at the failure zone, a second control decision to actuate a valve associated with the failure zone to deliver the fire suppressant agent to the failure zone.

### CROSS-REFERENCE TO RELATED PATENT APPLICATION

This application claims the benefit of and priority to U.S. Provisional Application No. 63/513,750, filed Jul. 14, 2023, the entire disclosure of which is hereby incorporated by reference herein.

### BACKGROUND

The present disclosure relates generally to fire suppression systems. More specifically, the present disclosure relates to diagnostics for fire suppression systems.

### SUMMARY

At least one implementation relates to a system. The fire suppression system includes a fire suppression system having a supply configured to house a fire suppressant agent, the fire suppression system configured to selectively provide the fire suppressant agent to one or more components within a monitored area, and a zone module in communication with the fire suppression system, the zone module having one or more processors and a memory storing instructions that, when executed by the one or more processors, cause the one or more processors to perform operations. The operations comprise identifying one or more zones within the monitored area, receiving, from detectors associated with each of the one or more zones within the monitored area, signals relating to one or more measured thermal characteristics associated with each of the one or more zones, and detecting, based on the signals, a potential thermal runaway event at a failure zone, the failure zone being one of the one or more zones within the monitored area. The operations also comprise initiating, in response to detecting the potential thermal runaway event, a first control decision to expel the fire suppressant agent from the supply, and initiating, based on detecting the potential thermal runaway event at the failure zone, a second control decision to actuate a valve associated with the failure zone to deliver the fire suppressant agent to the failure zone.

At least one implementation relates to a control circuit. The control circuit includes one or more processors and a memory storing instructions that, when executed by the one or more processors, cause the one or more processors to perform operations. The operations comprise identifying one or more zones within a monitored area, receiving, from detectors associated with each of the one or more zones within the monitored area, signals relating to one or more measured thermal characteristics associated with each of the one or more zones, and detecting, based on the signals, a potential thermal runaway event at a failure zone, the failure zone being one of the one or more zones within the monitored area. The operations also comprise initiating, in response to detecting the potential thermal runaway event, a first control decision to expel a fire suppressant agent, and initiating, based on detecting the potential thermal runaway event at the failure zone, a second control decision to actuate a valve associated with the failure zone to deliver the fire suppressant agent to the failure zone.

At least one implementation relates to a method for detecting and mitigating a potential thermal runaway event. The method includes identifying one or more zones within a monitored area, receiving, from detectors associated with each of the one or more zones within the monitored area, signals relating to one or more measured thermal characteristics associated with each of the one or more zones, and detecting, based on the signals, a potential thermal runaway event at a failure zone, the failure zone being one of the one or more zones within the monitored area. The method also comprises initiating, in response to detecting the potential thermal runaway event, a first control decision to expel a fire suppressant agent, and initiating, based on detecting the potential thermal runaway event at the failure zone, a second control decision to actuate a valve associated with the failure zone to deliver the fire suppressant agent to the failure zone.

At least one implementation relates to a system. The system can include one or more processors to execute one or more operations described herein. For example, the system can include one or more processors to identify one or more zones within a monitored area, receive, from detectors associated with each of the one or more zones within the monitored area, signals relating to one or more measured thermal characteristics associated with each of the one or more zones, and detect, based on the signals, a potential thermal runaway event at a failure zone, the failure zone being one of the one or more zones within the monitored area. The system can be provided as one or more modules.

This summary is illustrative only and is not intended to be in any way limiting.

Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a fire suppression system, according to an implementation.

FIG. 2 is schematic illustration of components of the fire suppression system of FIG. 1, according to another implementation.

FIG. 3 is a block diagram of a zone module for the fire suppression system of FIG. 1, according to an implementation.

FIG. 4 is a block diagram of the fire suppression system of FIG. 1 in a configuration in a monitored environment, according to an implementation.

FIG. 5 is a block diagram of the fire suppression system of FIG. 1 in a configuration in a monitored environment, according to an implementation.

FIG. 6 is a block diagram of the fire suppression system of FIG. 1 in a configuration in a monitored environment, according to an implementation.

FIG. 7 is a block diagram of the fire suppression system of FIG. 1 in a configuration in a monitored environment, according to an implementation.

FIG. 8 is a flow diagram of a process for a fire detection and prevention system, according to some implementations.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a thermal runaway detection and prevention system for preventing, eliminating, and/or mitigating a failure or thermal runaway event is shown and described. The system can include a fire suppression system having a supply (e.g., a container, a plurality of containers, etc.) configured to house a fire suppressant agent, where the fire suppression system is configured to selectively provide the fire suppression agent to one or more components within a monitored area. The system can also include a zone module (e.g., having one or more processors and a memory) in communication with the fire suppressions system. The zone module may be configured to identify (e.g., determine) one or more zones to be monitored within the monitored area, and may receive signals (e.g., thermal signals from respective detectors) relating to one or more thermal characteristics associated with each of the zones (e.g., radiant heat, thermal radiation, temperature, etc.). The zone module may also detect, based on the signals (e.g., thermal signals), a potential failure or thermal runaway event at a failure zone (e.g., one of the one or more identified zones where a failure or runaway event is detected). In response to detecting the potential thermal runaway event, the zone module can initiate a control decision (e.g., command, instruction, automated action, etc.) to expel the fire suppressant agent from the supply. Further, based on detecting the potential thermal runaway event at the failure zone, the zone module can initiate another control decision to actuate a valve associated with the failure zone, for example to deliver the fire suppressant agent to the failure zone (and components thereof) to prevent, eliminate, and/or mitigate the failure or thermal runaway event.

In some circumstances, given that the source of a potential failure or thermal runaway event may be located in difficult to analyze and/or access locations (e.g., within a battery pack, within a battery module, remote from an external detection system, etc.), the detection/prediction of a failure or thermal runaway may be difficult or impractical. Advantageously, the system (e.g., zone module) of the present disclosure may receive inputs from detectors associated, respectively, with a plurality of zones (e.g., 4, 6, 10, 12, etc.), for example to efficiently and effectively detect/determine whether a potential failure or thermal runaway event is, or potentially will, occur within one of the zones. Further, in some circumstances, during/leading up to a failure or potential thermal runaway event, expellant gasses/liquids may be difficult to cool or control, for example due to their high temperatures, high volumes, and/or high pressures. Advantageously, if a (potential) failure or thermal runaway event is detected, the system (e.g., the zone module) of the present disclosure is configured to actuate an appropriate valve associated with the area where the runaway event is detected, thereby facilitating selective and controlled delivery of the fire suppressant to the appropriate zone to prevent, mitigate, or eliminate the detected event. Further, and as explained herein, the system of the present disclosure advantageously the thermal runaway detection and prevention system (e.g., zone module, etc.) of the present disclosure facilitates monitoring multiple zones within an area, and provides selective and controlled delivery of a fire suppressant agent to the appropriate zone/area of the multiple zones being monitored.

As such, the system (e.g., zone module) of the present disclosure offers a multi-zone monitoring and delivery system, which is configured to selectively control a plurality of valves (e.g., coupled to a single supply) for targeted delivery of a fire suppressant agent, rather than duplicating and/or implementing a plurality of delivery devices (e.g., containers, actuators, etc.) for delivery of a fire suppressant agent to associated areas. As such, the system of the present disclosure provides detection and monitoring components that offer increased efficiencies and/or reduce resource consumption (e.g., increase response times, reduce resource consumption, etc.), for example compared to traditional detection and prevention systems that struggle to detect/predict failures or runaway events in difficult to analyze/access locations and/or struggle to control delivery of fire suppressant agent to appropriate locations and/or at appropriate times.

As described herein, the thermal runaway detection and prevention system may be configured to prevent, eliminate, and/or mitigate a failure. A failure may include, for example, a fire, a potential fire, a thermal runaway event, a potential thermal runaway event, or similar situations that relate to abnormal thermal conditions within an environment (e.g., increase in radiant heat, thermal radiation, temperature, pressure, off-gas, etc.). For example, a “potential” fire may include situations (e.g., data, signals, etc.) that matches conditions or thresholds associated with a fire or an expectation that a fire will occur if not addressed. Similarly, a “potential” thermal runaway event may include situations (e.g., data, signals, etc.) that matches conditions or thresholds associated with a thermal runaway or an expectation that thermal runaway will occur if not address. Further, a failure (e.g., a fire, thermal runaway event, etc.) may be situations (e.g., data, signals, etc.) that match conditions or thresholds associated where a failure may occur, or may be occurring.

### System Overview

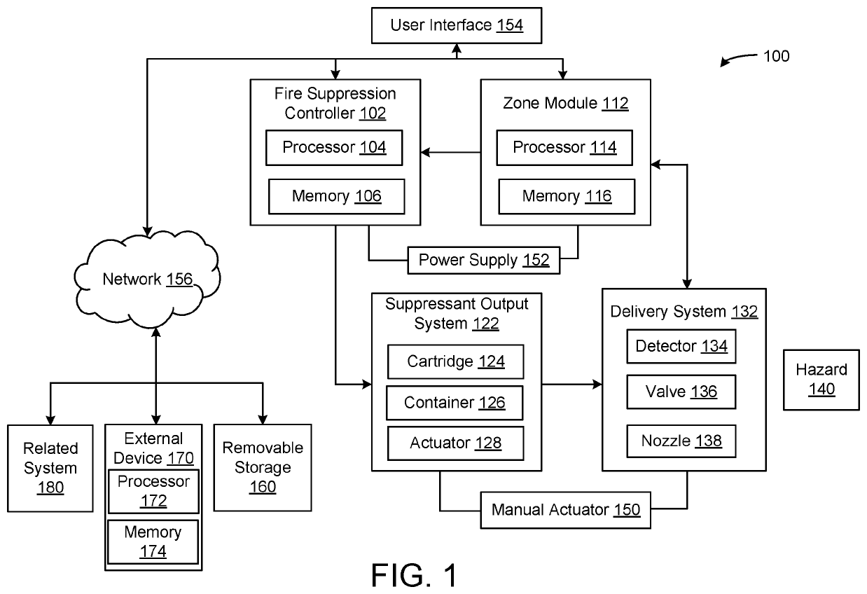

Referring to FIG. 1, a fire suppression system, fire extinguishing system, or fire management system is shown as system 100, according to an implementation. The system 100 may be configured to identify the presence of a fire or thermal runaway event (e.g., through the use of one or more sensors or detectors). Once a fire or thermal runaway event has been identified (e.g., through the sensors or a manual actuation of the system 100, e.g., by a user), the system 100 directs fire suppressant (e.g., water, a chemical agent, etc.) toward the fire or event to suppress (e.g., reduce the intensity of, extinguish, prevent from restarting, mitigate runaway of, etc.) the fire. The system 100 may direct the fire suppressant to only a small area identified as being nearby the fire or may blanket or flood a larger area with suppressant.

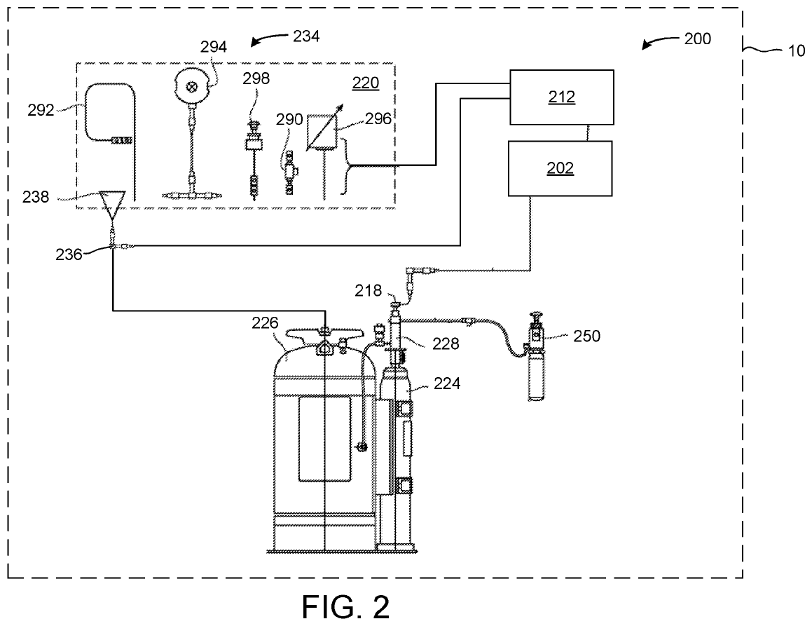

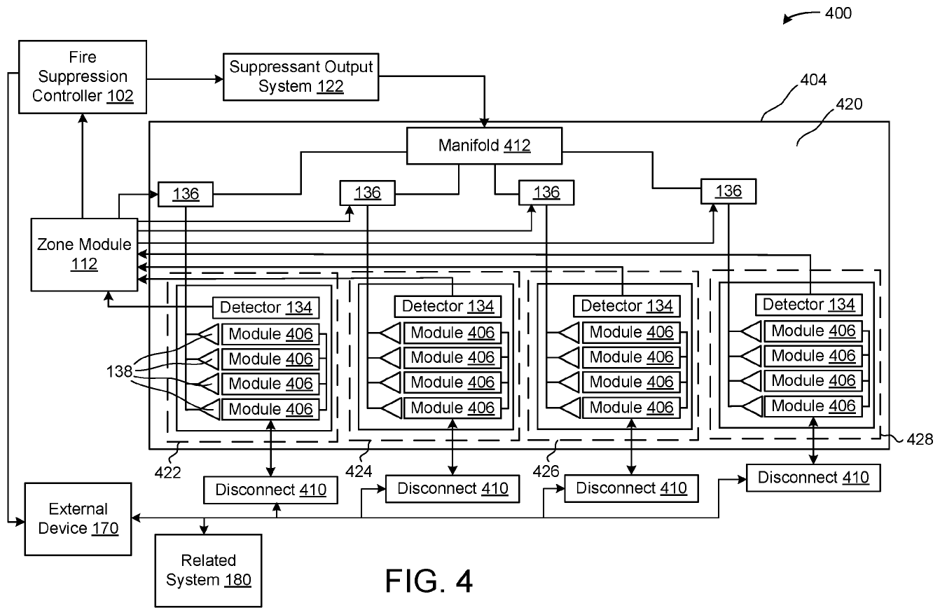

The system 100 may be utilized in a variety of environments or applications. In an implementation, the system 100 is used onboard a vehicle (e.g., a mining vehicle, construction equipment, logging equipment, etc.), such as shown in the configuration of FIG. 2. For example, the system 100 may be used within one or more components of a battery pack (e.g., a subpack, etc.) onboard a vehicle, such as in the configuration of FIG. 4. In other implementations, the system 100 is used within one or more rooms of a building (e.g., in a kitchen, a workshop, an aircraft hangar, a museum, a data center, a storage facility, etc.). In yet other implementations, the system 100 is used throughout (e.g., within, atop, nearby, etc.) another type of structure (e.g., a facility that processes and/or store petroleum products, etc.).

The system 100 includes a fire suppression, mitigation, or prevention controller, shown as fire suppression controller 102, which may be configured to control operation of one or more components of the system 100. The fire suppression controller 102 is shown to include a processor 104 and a memory device, shown as memory 106. The memory 106 may contain one or more instructions that, when executed by the processor, cause the fire suppression controller 102 to execute one or more of the processes described herein. The fire suppression controller may be configured to (e.g., structured to) receive one or more inputs (e.g., data, commands, etc.) from and/or provide one or more outputs (e.g., data, commands, etc.) to other components of the system 100, as discussed herein.

The system 100 also includes a zone or area controller, zone circuit, or zone or area control system, shown as zone module 112, which is operatively (e.g., communicably) coupled to the fire suppression controller 102. The zone module 112 may be configured to control operation of one or more components of the system 110. As shown, the zone module 112 includes a processor 114 and a memory device, shown as memory 116. The memory 116 may contain one or more instructions that, when executed by the processor, cause the zone module 112 to execute one or more of the processes described herein. The zone module 112 may be configured to (e.g., structured to) receive one or more inputs (e.g., data, commands, etc.) from and/or provide one or more outputs (e.g., data, commands, etc.) to other components of the system 100 (e.g., the fire suppression controller 102, an actuator, a detector, a valve, etc.), as discussed herein. The zone module 112 can include (e.g., in memory 116) any one or more operations, functions, rules, heuristics, logic, algorithms, machine learning models, data structures, or various combinations thereof to execute one or more processes described herein.

The system 100 further includes a fire suppression or fire suppressant output system, shown as suppressant output system 122, that is operatively (e.g., communicably) coupled to the fire suppression controller 102. The suppressant output system 122 is configured to control the release of fire suppressant by and/or to the system 100. For example, the suppressant output system 100 may be configured to control the release of fire suppressant to a delivery system (e.g., within a storage facility, a battery pack, a battery sub-pack, a battery module, etc.), for example to facilitate mitigating, preventing, and/or suppressing a fire or thermal runaway event.

As shown, the suppressant output system 122 includes one or more pressurized cylinder assemblies containing expellant gas, shown as cartridge 124. The cartridge 124 may be coupled (e.g., fluidly coupled, operatively coupled, etc.) to one or more supplies of fire suppressant or containers of fire suppressant (e.g., vessels, tanks, canisters, vats, etc.), shown as suppressant container or container 126. In an implementation, the cartridge 124 is configured to provide the expellant gas to pressurize the container 126, for example for delivery of the fire suppressant agent under an operating pressure (e.g., to one or more components of the system 100). In some implementations, the suppressant output system 122 includes one or more activators, actuators, or flow control devices, shown as an actuator 128. The actuator 128 may be coupled to the cartridge 124, for example to open, puncture or rupture, or otherwise manipulate a disc of the cartridge containing the pressurized expellant gas (e.g., nitrogen), to pressurize the container 126 for delivery of the fire suppressant agent.

In an implementation, the container 126 contains a type of fire suppressant that is selected based upon the type of hazard that will be protected by the system 100. In some implementations, the fire suppressant is water. For example, the container 126 may be a tank of water, a well, or a municipal water supply. In some implementations, the fire suppressant is a fire suppressant agent. For example, the fire suppressant may be liquid agent, a dry chemical agent, a foam agent, or another type of agent. In some implementations, the fire suppressant is a gas (e.g., an inert gas, etc.). In other implementations, the system 100 is configured to sequentially provide two or more different types of fire suppressant from the same nozzle or set of nozzles. For example, the system 100 may initially supply a fire suppressant agent to extinguish flames affecting a hazard, and subsequently supply water to cool the hazard and prevent reignition of the fire.

In some implementations, the fire suppressant is stored in the container 126 under pressure. For example, an expellant gas may be added to the container 126. In such implementations, the container 126 is coupled with a flow control device (e.g., a valve), which may be opened to release the fire suppressant from the container 126, thereby initiating the flow of the fire suppressant toward a nozzle, as discussed below. In some implementations, the fire suppressant is stored a relatively low pressure (e.g., at atmospheric pressure). In such implementations, expellant gas may be stored in a separate container (e.g., an expellant gas cartridge, the cartridge 124, etc.). As discussed above, the actuator 128 may be configured to selectively fluidly couple the cartridge 124 to the container 126, such that the expellant gas passes into the container 126 and forces the fire suppressant toward a nozzle. For example, the actuator 128 may be a valve. In another example, the actuator 128 may include a puncturing device (e.g., a needle or pin) that is configured to rupture a seal of the cartridge 124.

The system 100 is also shown to include a detection and delivery system, shown as delivery system 132. As shown, the delivery system 132 is operatively (e.g., communicably) coupled to the suppressant output system 122 and/or the zone module 112. The delivery system 132 may be configured to control the release of fire suppressant by and/or to the system 100, as discussed below. The delivery system 132 may also be configured to (e.g., structured to) provide one or more outputs (e.g., data, commands, etc.) to components of the system 100 (e.g., the zone module 112), and/or receive one or more inputs (e.g., data, commands, fire suppressant, etc.) from components of the system 100 (e.g., the zone module 112, the suppressant output system 122), as discussed below.

The delivery system 132 is shown to include a fire detection circuit or system, shown as a detector 134. The detector 134 may be configured to indicate the presence of a fire or a thermal runaway event (e.g., whether or not a fire is present or is likely to be present). The detector 134 may provide additional information relating to the fire or the thermal runaway event (e.g., a location of a fire or thermal runaway event, a temperature of the fire, a size of the fire, etc.). The detector 134 may be configured to also be configured to provide one or more inputs (e.g., commands, data, etc.) to components of the system 100 (e.g., the zone module 112), for example to indicate a fire has been detected and/or initiate control of one or more components of the system 100 to release the fire suppressant.

In some implementations, the detector 134 is or includes one or more sensors, and may be configured to provide sensor data indicating the presence or absence of a fire or thermal runaway event, as discussed above. For example, the detector 134 may include a spot thermal detector configured to provide an indication of a temperature of the surrounding air. Components of the system 100 (e.g., the zone module 112) may determine that a fire or thermal runaway event is present when a sport thermal detector (e.g., the detector 134) indicates that the surrounding air exceeds a predetermined threshold temperature. In other implementations, the detector 134 includes linear detection wires (e.g., two wires) that are separated by an insulating material with a predetermined threshold melting temperature. When the threshold melting temperature is exceeded, the wires may be brought into contact with one another, and provide an electrical signal to components of the system 100 (e.g., the zone module 112) indicating the presence of a fire or thermal runaway event. In other implementations, the detector 134 includes one or more optical sensors, which may be configured to differentiate between open flames and hydrocarbon signatures. In yet other implementations, the detector 134 includes linear pressure detectors that monitor the pressure of a volume of a gas (e.g., air) that increases with the surrounding temperature. Components of the system 100 (e.g., the zone module 112) may determine that a fire is present in response to the pressure of the gas exceeding a predetermined threshold pressure. In other implementations, the detector 134 is or includes another suitable type of sensor.

As shown in FIG. 1, the delivery system 132 also includes one or more activators, actuators, or flow control devices, shown as a valve 136. The valve 136 may be coupled (e.g., fluidly coupled, operatively coupled, etc.) to one or more supplies of fire suppressant or containers of fire suppressant (e.g., vessels, tanks, canisters, vats, etc.), for example the container 126 of the suppressant output system 122. In some implementations, the delivery system 132 is in communication with a manifold (e.g., as shown in at least FIG. 4) or delivery system, for example to couple (e.g., fluidly couple, operatively couple, etc.) one or more supplies of fire suppressant (e.g., the container 126) to one or more valves 136 (e.g., a plurality of valves), as discussed below. The valve 136 may further be configured to receive one or more inputs (e.g., commands, data, etc.) from components of the system 100 (e.g., the zone module 112), for example to transition between different operating configurations or delivery conditions (e.g., an open or activated configuration, a closed or deactivated configuration, etc.).

In an implementation, when the valve 136 is activated, the valve 136 may be configured to initiate a flow of the fire suppressant from the suppressant output system 122 (e.g., the container 126) to one or more outlets or flow shaping devices, shown as a nozzle 138. The nozzle 138 may be fluidly coupled to the container 126 by one or more conduits (e.g., pipes, hoses, etc.), manifolds, flow control devices (e.g., valves), or other devices. Further, the nozzle 138 may be positioned and/or configured to direct the fire suppressant toward one or more items, or a hazard area or hazard 140.

In some implementations, the delivery system 132 and/or the suppressant output system 122 operatively couples one or more pull stations, manual interfaces, manual indicators, or manual activators, shown as manual activator 150. The manual activator 150 may be configured to provide an interface through which a user can manually trigger an actuation of the system 100. For example, the manual activator 150 may permit a user to manually indicate the presence of a fire or anticipated thermal runaway event. The manual activator 150 may include a button, lever, switch, knob, or other input device configured to receive an input from a user.

In some implementations, the system 100 includes one or more electrical energy supplies or storage devices, shown as power supply 152. The power supply 152 can electrically couple the fire suppression controller 102 and/or the zone module 112, and may be configured to supply electrical energy to power the fire suppression controller 102, the zone module 112, and/or other devices within the system 100 (e.g., the actuator 128, the detector 134, the valve 136, etc.). In some implementations, the power supply 152 includes energy storage devices, such as batteries or capacitors. In some implementations, the power supplies include connections to a power grid, generators (e.g., an alternator coupled to an engine of a vehicle, an electric motor operating as a generator to provide a braking force, etc.), solar panels, or other types of energy sources. The power supply 152 may provide direct current electrical energy, or alternating current electrical energy.

In some implementations, the system 100 includes one or more input devices, output devices, or interfaces, shown as user interface 154. The user interface 154 may be operatively coupled to the fire suppression controller 102 and/or the zone module 112. The user interface 154 may facilitate operator control over the system 100. The user interface 154 may be configured to receive information provided by a user (e.g., commands, selections, data, etc.) and provide the information to the fire suppression controller 102 and/or the zone module 112. For example, the user interface 154 may be configured to receive a user selection of an operating mode for the system 100 (e.g., a baseline mode in which sensor data is recorded to a storage device to determine baseline operating conditions of the system 100, a maintenance mode in which the actuator 128 or valve 130 is disabled, a standard operating mode, etc.). Additionally or alternatively, the user interface 154 may be configured to provide information (e.g., system statuses, sensor measurements, etc.) from the fire suppression controller 102 and/or the zone module 112 in a format that can be consumed by a user (e.g., visually, audibly, etc.). For example, the user interface 154 may indicate a current operating mode of the system 100, may indicate the detection of a fire or potential of a thermal runaway event, the date and time at which a discharge event (i.e., a dispensing of fire suppressant) occurred, an indication of a fault detected, etc. The user interface 154 may include one or more input devices, such as touchscreens, switches, knobs, dials, buttons, keyboards, mice, microphones, or other input devices. Further, the user interface 154 may include one or more output devices, such as displays, lights, speakers, haptic feedback devices, or other output devices.

In some implementations, the system 100 includes additional systems of devices that may be connected over a network 156. The network 156 may facilitate communication of information (e.g., commands, data, etc.) between one or more components of the system 100 (e.g., to/from the fire suppression controller 102, the zone module 112, external devices, related systems, a storage system, etc.). The network 156 may be a local area network or a wide area network (e.g., Internet). In other implementations, components of the system 100 communicate directly. For example, one or more of the components of the system 100 may communicate over a wired connection (e.g., Ethernet, fiber optics, etc.), or may communicate wirelessly over a wireless connection (e.g., Wi-Fi, Bluetooth, Zigbee, a cellular network, etc.).

In some implementations, the system 100 includes one or more memory devices or physical media, shown as removable storage 160. The removable storage 160 may be operatively coupled to (e.g., via the network 156) the fire suppression controller 102 and/or the zone module 112. In an implementation, the removable storage 160 is configured to store data for transportation to other devices (e.g., an external device). Accordingly, the removable storage 160 may be removably coupled to other devices. In some implementations, the removable storage 160 is configured to receive commands, for example causing the removable storage 160 to record, or erase data. In other implementations, the removable storage 160 is configured to removably couple (e.g., directly) the fire suppression controller 102 and/or the zone module 112. For example, the fire suppression controller 102 and/or the zone module 112 may include or define a port or interface that can be selectively coupled to the removable storage 160. In such implementations, the fire suppression controller 102 and/or the zone module 112 may define a universal serial bus (USB) port, and the removable storage 160 may be a flash drive including a corresponding USB interface.

In some implementations, the system 100 is operatively coupled to one or more external devices, shown as external device 170. The external device 170 is shown to include a processor 172 and a memory device, shown as memory 174. The memory 174 may contain one or more instructions that, when executed by the processor 172, cause the external device 170 to execute one or more of the processes described herein. The external device 170 may be configured to receive data from the system 100 (e.g., via the network 156). The external device 170 may store the data, analyze the data, provide notifications to a user based on the data (e.g., based on the analysis of the data), and/or provide commands to the fire suppression controller 102, the zone module 112, and/or other components of the system 100 based on the data. In an implementation, the external device 170 is a building management system (BMS) controller, for example of a building management system. In some implementations, the external device 170 is a user device, such as a smartphone, a tablet, a laptop computer, or a desktop computer. In other implementations, the external device 170 is a server. The external device 170 may include one or more user interfaces to facilitate user interaction with the external device 170.

In other implementations, the external device 170 and components of the system 100 (e.g., the fire suppression controller 102, the zone module 112, etc.) are isolated from one another (e.g., configured as air-gapped computers). In such implementations, the removable storage 160 may transfer data between the external device 170 and components of the system 100. For example, the removable storage 160 may be operably coupled to the fire suppression controller 102 (and/or the zone module 112), and the fire suppression controller 102 (and/or the zone module 112) may command the removable storage 160 to record a set of information (e.g., sensor data, operating parameters, fault detection information, response information, etc.). The removable storage 160 may be disconnected from the fire suppression controller 102 (and/or the zone module 112), and subsequently connected to the external device 170. The external device 170 may then read the data from the removable storage 160.

In some implementations, the system 100 is configured to communicate with one or more related systems, shown as related system 180. The related system 180 may have functions that are related to the operation of the system 100, and the related system 180 may provide information (e.g., data, commands, etc.) regarding the operation of these functions to components of the system 100 (e.g., the fire suppression controller 102, the zone module 112, etc.).

For example, if the system 100 is installed on a vehicle, the related system 180 may be a control system for the vehicle. The related system 180 may communicate information to/from components of the system 100 (e.g., the fire suppression controller 102, the zone module 112, etc.), such as vehicle speed, engine speed, engine temperature, fuel levels, or other vehicle-specific information. Further, the related system 180 may receive information from components of the system 100 (e.g., the fire suppression controller 102, the zone module 112, etc.), for example to initiate an automated action in response to detection of a fire or a potential thermal runaway event, such as an instruction to power down a power source, disconnect a power source, perform maintenance on a power source, provide an indication of a detected failure or potential failure at a power source of device (e.g., valve, actuator, etc.). In some implementations, this communication occurs over a controller area network (CAN) bus.

In another example, if the system 100 is installed within a building (e.g., a storage facility, a data center, a kitchen, a museum, etc.), the related system 180 may be a building control system for the building. The related system 180 may communicate information to/from components of the system 100 (e.g., the fire suppression controller 102, the zone module 112, etc.) regarding the status and/or operation of the building, such as building temperatures, air flow rates, the operation status of various ventilation devices, or other building-specific information. Further, the related system 180 may receive information from components of the system 100 (e.g., the fire suppression controller 102, the zone module 112, etc.), for example to initiate an automated action in response to detection of a fire or a potential thermal runaway event, such as an instruction to power down a power source, disconnect a power source, perform maintenance on a power source, provide an indication of a detected failure or potential failure at a power source of device (e.g., valve, actuator, etc.).

### System Configuration

Referring to FIG. 2, components of a suppression system 200 are shown as a configuration of the system 100, according to an implementation. The system 200 may include components that are substantially similar to the system 100, except as otherwise specified herein. The system 200 may be included within a vehicle 10 (e.g., an electric vehicle, a mining vehicle, a logging vehicle, etc.). For example, various of the components of the system 200 may be implemented within one or more components of a battery pack (e.g., a subpack, etc.) onboard the vehicle 10. Accordingly, the system 200 may be configured to address one or more fires or potential thermal runaway events onboard the vehicle 10.

In an implementation, the system 200 includes a fire suppressant agent supply coupled to one or more nozzles (e.g., shown as nozzle 238) to protect one or more components or devices within a hazard area or monitored area, shown as monitored area 220. As shown, the fire suppressant agent supply may include one or more storage tanks or cylinders (shown as container 226) containing the fire suppressant, such as a chemical agent. The container 226 may include a corresponding pressurized cylinder assembly, shown as cartridge 224, containing expellant gas. The cartridge 224 is configured to provide the expellant gas to pressurize the container 226 for delivery of the fire suppressant agent under an operating pressure to the nozzle 238 to address a fire or potential thermal runaway event affecting the monitored area 220. In some implementations, the cartridge 224 includes a rupture device (shown as actuator 228), which punctures a rupture disc of the cartridge 224 containing the pressurized expellant gas (e.g., nitrogen, etc.) to pressurize the container 226 for delivery of the fire suppressant agent.

In order to operate the actuator 228, the system 200 may provide for automatic actuation and manual operation of the actuator 228 to provide for respective automated and manual delivery of the chemical agent (e.g., in response to a fire or potential thermal runaway event to protect or mitigate the effects to the monitored area 220). The actuator 228 may include a puncturing pin or member that is driven into the rupture disc of the cartridge 224 for release of the pressurized gas. The puncturing pin of the actuator 228 may be driven electronically or pneumatically to puncture the rupture disc of the cartridge 224.

One or more manual activators, shown as manual activation cartridge 250, may be used to manually actuate the actuator 228. The manual activation cartridge 250 may include a volume of compressed gas and an interface (e.g., a button). When the interface is activated, the compressed gas is released into a conduit, which is fluidly coupled with the actuator 228. The conduit may direct the compressed gas to a chamber of the actuator 228, such that the compressed gas forces the puncturing pin downward to puncture the rupture disc of the cartridge 224.

In some implementations, a controller (shown as fire suppression controller 202) is configured to provide one or more electrical signals to automatically actuate the actuator 228. The actuator 228 may include a protracted actuation device (PAD) 218 for driving the puncturing pin of the actuator into the rupture disc. The PAD 218 may include an electrically coupled rod or member that is disposed above the puncturing pin. When an electrical signal is delivered to the PAD 618 (e.g., from the fire suppression controller 202), the rod of the PAD 218 is driven directly or indirectly into the puncturing pin, which punctures the rupture disc of the cartridge 224.

In an implementation, the fire suppression controller 202 is also operatively coupled to a zone module (as shown as zone module 212), which is operatively couple to one or more detectors, shown as detector 234. The detector 234 is shown to include analog and digital devices for various modes of fire detection. For example, the detector 234 can include a spot thermal detector 290 to determine when the surrounding air exceeds a set temperature, a linear detection wire 292 which conveys a detection signal from two wires that are brought into contact upon a separating insulation material melting in the presence of a fire, an optical sensor 294 which differentiates between open flames an hydrocarbon signatures, and/or a linear pressure detector 296 in which pressure of an air line increases in the presence of sufficient temperature. The manual activator 298 (e.g., a push bottom) may also be configured to send an actuating signal to the zone module 212 and/or the fire suppression controller 202.

As will be discussed in greater detail below, in an implementation the zone module 212 is configured to receive information (e.g., data, sensor data, temperature information, etc.) from the detector 234 (e.g., via components 290-298), for example indicating a thermal characteristic associated with the monitored area 220. Based on the information (e.g., sensor data, thermal characteristic, etc.), the zone module 212 may determine whether a fire or potential thermal runaway event is present in the monitored area 220 (e.g., via a comparison to a predetermined threshold, a range of potential values, etc.). If the zone module 212 determines a fire or potential thermal runaway event is present (e.g., in the monitored area 220), the zone module 212 may initiate one or more automated actions to mitigate or prevent the fire or thermal runaway event.

For example, the zone module 212 may communicate one or more instructions (e.g., commands) to the fire suppression controller 202, for example to initiate an automated operation of the system 200 (e.g., actuation of the actuator 228, etc.) to deliver a fire suppressant agent to the monitored area 220, as discussed above. In some implementations, the zone module 212 may communicate one or more instructions (e.g., commands) to a user interface, for example to provide a warning or instruction to a user to initiate manual operation of the system 200 (e.g., actuation of the actuator 228 etc.) to deliver a fire suppressant agent to the monitored area 220, as discussed above.

Finally, and as will be discussed in greater detail below, in an implementation the system 100 and/or the system 200 is/are configured to monitor, detect, and/or mitigate fire or potential thermal runaway events within a plurality of zones or monitored areas (e.g., a plurality of the monitored areas 220). In this regard, the zone module 212 may be configured to receive thermal characteristic information relating to a plurality of monitored areas or zones (e.g., a plurality of monitored areas 220), determine whether a fire or potential thermal runaway event is present in any of the plurality of areas, and (if present) initiate one or more automated actions to mitigate or prevent the fire or thermal runaway event. For example, the zone module 212 may communicate one or more instructions (e.g., commands) to activate a valve associated with an area (e.g., the valve 236 associated with the monitored area 220), or instructions to a user (e.g., via a user interface) to perform remedial measures at a specified area, in order to prevent, mitigate, and/or extinguish a fire or potential thermal runaway event.

### Zone Module and Fire Suppression System Configuration

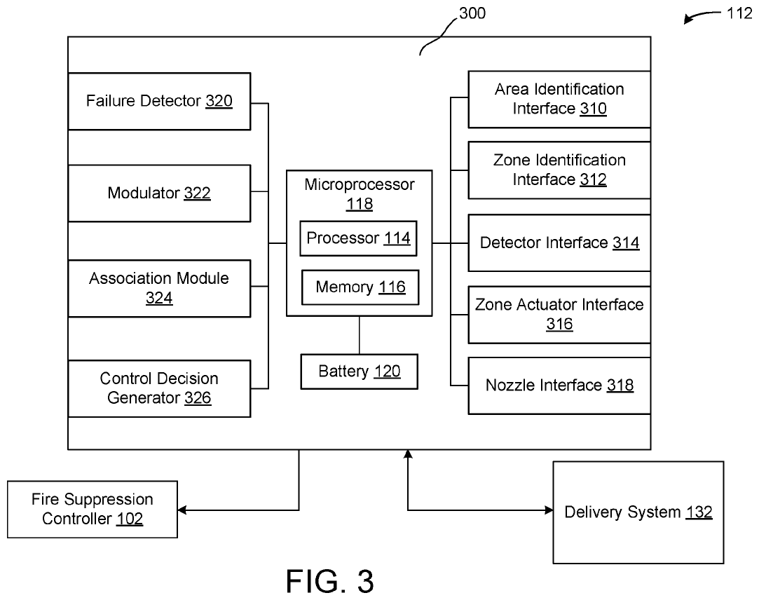

Referring generally to FIGS. 3-4, a zone module and a fire suppression system configuration are shown, according to an implementation. In this implementation, the zone module is the zone module 112 of FIG. 1. The zone module 112 may be configured to monitor one or more zones within a monitored area, determine the presence of a fire or potential thermal runaway event within one or more of the monitored zones, and/or control the delivery of a fire suppressant to one or more of the monitored zones to prevent, mitigate, and/or extinguish a fire or thermal runaway event. As shown in FIG. 4, the fire suppression system includes a monitored area having one or more zones within the monitored area. Each monitored zone may include a detector and/or be associated with one or more valves, for example to facilitate detection of a fire or potential thermal runaway event and/or control delivery of a fire suppressant agent to the monitored zone. In this regard, the zone module 112 of FIG. 3 can be implemented within the fire suppression system of FIG. 4, for example to detect a fire or potential thermal runaway event, and/or control delivery of a fire suppressant agent to one or more of the monitored areas to mitigate or prevent the fire or thermal runaway event.

Referring now to FIG. 3, the zone module 112 may include a base, chassis, or substrate, shown as a printed circuit board (PCB) 300, that supports the various components and circuitry of the zone module 112. The PCB 300 may include various electrical components that facilitate the connections and the functionalities described herein. In some implementations, the PCB 300 is contained within and/or supported by a housing. Although the zone module 112 is shown as having a single PCB 300 that supports and connects the various components of the zone module 112, in other implementations, the zone module 112 is split across multiple PCBs 300. In other implementations, the zone module is formed of other suitable hardware or software programming components, for example application programming interfaces, and/or modules or packages formed of any suitable computer language software. As shown, the zone module 112 includes the processor 114 and the memory 116 implemented as a microprocessor 118 coupled to (e.g., mounted on) the PCB 300. In other implementations, the processor 114 and the memory 116 are otherwise configured. As described further herein, the zone module 112 can include various components, including but not limited to a modulator 322, an association module 324, a control decision generator 326, etc., which can be implemented using the processor 114 and memory 116 of the zone module 112.

In some implementations, the zone module 112 includes one or more energy storage devices (e.g., batteries, capacitors, etc.), shown as internal battery 120. The battery 120 may be coupled to the PCB 300, and may be configured to power one or more functions of the zone module 112. For example, the battery 120 may provide a continuous power source regardless of whether or not the zone module 112 is connected to the power supply 152. The inclusion of internal battery 120 may be useful for certain continuous functions of the zone module 112, such as operating an internal clock. In some implementations, the battery 120 is charged via the power supply 152.

As shown in FIG. 3, the zone module 112 includes an area identification interface 310. The area identification interface 310 may be operatively coupled to one or more components of the system 100 (e.g., the fire suppression controller 102, the user interface 154, the related system 180, etc. via the network 156). In an implementation, the area identification interface 310 is configured to facilitate communication between the zone module 112 and the components of the system 100, for example to provide one or more outputs and/or receive one or more inputs (e.g., data, commands, configuration layouts, hardcoded rules or instructions, etc.). According to an implementation, the area identification interface 310 is configured to receive an input (e.g., data, configuration layouts, rules, etc.), and identify or determine an area to be monitored or a monitored area, as discussed below. In some implementations, the monitored area (e.g., input) is received from the fire suppression controller 102 (e.g., via hardcoded rules or configuration data, etc.), the user interface 154 (e.g., via a configuration profile, etc.), and/or the related system 180 (e.g., via hardcoded system configurations or rules, etc.). In this regard, the area identification interface 310 may be configured to allow the zone module 112 to receive an input associated with, and/or identify or determine, an area to be monitored by the zone module 112.

The zone module 112 is shown to also include a zone identification interface 312. The zone identification interface 312 may also be operatively coupled to one or more components of the system 100 (e.g., the fire suppression controller 102, the user interface 154, the related system 180, etc. via the network 156). In an implementation, the zone identification interface 312 is configured to facilitate communication between the zone module 112 and components of the system 100, for example to provide one or more outputs and/or receive one or more inputs (e.g., data, commands, configuration layouts, hardcoded rules or instructions, etc.). According to an implementation, the zone identification interface 312 is configured to receive an input (e.g., data, configuration layouts, rules, etc.), and determine one or more zones to be monitored within the monitored area, as discussed below. In some implementations, the identified zones or zone identification information is received and/or provided by the fire suppression controller 102 (e.g., via hardcoded rules or configuration data, etc.), the user interface 154 (e.g., via a configuration profile, etc.), and/or the related system 180 (e.g., via hardcoded system configurations or rules, etc.).

According to an implementation, the zone identification interface 312 is further configured to identify and/or determine one or more components, devices, or configurations associated with each identified zone. For example, the zone identification interface 312 may identify four unique zones (as shown in at least FIG. 4). Further, the zone identification interface 312 may identify or determine that each zone includes a detector, a plurality of storage modules (e.g., four storage modules, etc.), and/or a plurality of nozzles (e.g., four nozzles, etc.) for controllably releasing a fire suppressant agent (as shown in at least FIG. 4). In other implementations, the zone identification interface 312 identifies or determines another number of zones (e.g., 2, 4, 6, 10, etc.), which may include any suitable number or type of device (e.g., two storage modules, 100 storage devices or cells, one battery sub-pack, one battery pack, etc.) and/or suppression component or system (e.g., an agent canister, an agent delivery channel, etc.). In this regard, the zone identification interface 312 may be configured to allow the zone module 112 to receive an input associated with, and/or identify or determine, the number/characteristics of the components, devices, and/or configurations associated with each zone to be monitored (within the monitored area) by the zone module 112.

The zone module 112 is further shown to include a detector interface 314. The detector interface 314 may be operatively coupled to one or more detectors (e.g., the detector 134), and may facilitate communication between the zone module 112 and the one or more detectors. For example, the detector interface 314 may facilitate receiving one or more inputs (e.g., data, commands, etc.) measured (e.g., detected, determined, etc.) at the detector 134. In an implementation, the input relates to one or more characteristics of a zone (or a component therein) associated with the detector 134. For example, the input may relate to a thermal characteristic of a component or a device within the zone (e.g., battery pack, battery subpack, battery module, battery cell, etc.). The thermal characteristic may relate to, for example, radiant heat, thermal radiation, temperature, etc. of the zone as a whole and/or individual components therein (e.g., a battery module, a battery cell, etc.). It should be understood that while the characteristics of the zone (or components therein) are described herein as thermal characteristics, it is contemplated that the characteristic may relate to another suitable characteristic associated with a zone and/or one or more components within the zone as it relates to a potential fire or thermal runaway event (e.g., optical characteristics, gas emission, pressure, fluid flow, fluid levels, power output, power input, etc., or any combination thereof). In this regard, the detector interface 314 may be configured to allow the zone module 112 to receive an input associated with the thermal characteristics of a zone and/or components therein (e.g., from an associated a detector), as discussed below.

The zone module 112 further includes a zone actuator interface 316. The zone actuator interface 316 may be operatively coupled to one or more actuators (e.g., the valves 136), and may be configured to facilitate communication between the zone module 112 and the actuators. For example, the zone actuator interface 316 may facilitate receiving one or more inputs and/or providing one or more outputs (e.g., data, commands, instructions, etc.) to/from the actuator. In some implementations, the zone actuator interface 316 is configured to facilitate receiving an input (e.g., data, information), which may relate to one or more characteristics associated with the actuator. For example, the input may include information relating to a number of delivery devices (e.g., nozzles) in communication with an actuator, a number of components or devices serviced by an actuator, a number of sub-zones or zones serviced by an actuator, and/or any other suitable information associated with the performance of the actuator.

In an implementation, the zone actuator interface 316 is also configured to facilitate providing an output (e.g., command, instructions, etc.) to the actuator (e.g., valve 136), for example to control delivery of a fire suppressant agent to or through the actuator (and the associated zone, nozzle, and/or components thereof), as discussed below. In some implementations, the zone actuator interface 316 provides an output (e.g., command, instruction, etc.) to the actuator, which controls one of more characteristics of the actuator and/or the fire suppressant agent that moves through the actuator. For example, the output may control a configuration of the actuator (e.g., an open configuration, a closed configuration, etc.), a mode of the actuator (e.g., standby mode, suppression mode, maintenance mode, etc.), a timing of actuation of the actuator (e.g., open for 5, 10, 15, 20, 25, etc. minutes, etc.), and/or another suitable characteristic of the actuator. The output may also control one or more characteristics of the fire suppressant that moves to or through the actuator, for example an amount, a volume, a flow rate, a speed, a pressure, a direction, a time of outflow, etc. In this regard, the zone actuator interface 316 may be configured to facilitate communications between the zone module 112 and one or more actuators (e.g., valves 136), for example to selectively and individually control delivery of a fire suppressant agent to the one or more actuators.

The zone module 112 is also shown to include a nozzle interface 318. The nozzle interface 318 may be operatively coupled to one or more delivery interfaces or devices (e.g., nozzle 138), and may be configured to facilitate communication between the zone module 112 and the delivery interfaces. For example, in some implementations the nozzle interface 318 may facilitate receiving one or more inputs and/or providing one or more outputs (e.g., data, commands, etc.) to/from the delivery device. In some implementations, the nozzle interface 318 is configured to facilitate receiving an input, which may include information relating to one or more characteristics associated with the delivery device (e.g., minimum output, maximum output, discharge rate, discharge volume, etc.). In other implementations, the nozzle interface 318 is also configured to facilitate providing an output (e.g., command, instructions, etc.) to the delivery device, for example to control delivery of a fire suppressant agent to or through the delivery device (and the associated components thereof).

For example, the output may control one or more characteristics of the delivery device (e.g., a configuration, mode of the delivery device, timing of actuation, etc.) and/or one or more characteristics of the fire suppressant that moves to or through the delivery device (e.g., an amount, a volume, a flow rate, a speed, a pressure, a direction, a time of outflow, etc.). In some implementations, the nozzle interface 318 (e.g., via an output from the zone module 112) is configured to control a discharge duration, a flow, etc. of the delivery device, which may be optimized for one or more zone configurations. For example, the output may cause the delivery device to operate in a first configuration (e.g., a high flow configuration, etc.), for example until a zone has received a predetermined amount of fire suppressant (e.g., until a zone is flooded, etc.). Then, the zone module 112 (e.g., via feedback from one or more sensors, a feedback loop, automated control, etc. received at the nozzle interface 318) may communicate a command to the delivery device to operate in a second configuration (e.g., a low flow configuration), for example to provide a trickle overflow of fire suppressant agent, or spray a zone area. In this regard, the nozzle interface 318 may be configured to facilitate communications between the zone module 112 and one or more delivery devices (e.g., nozzles 138), for example to selectively and individually control delivery of a fire suppressant agent to the one or more delivery devices.

As discussed herein, in some implementations the nozzle interface 318 (e.g., via an output from the zone module 112) is configured to control a discharge duration, a flow, etc. of a plurality of delivery devices, which may be optimized for one or more zone configurations. For example, the output may cause a delivery device in a first zone to operate in a first configuration (e.g., a discharge configuration, etc.), for example until the first zone has received a predetermined amount of fire suppressant (e.g., for a predetermined amount of time, etc.). Then, the zone module 112 (e.g., via a feedback loop, automated control, etc.) may communicate a command to the delivery device in the first zone to operate in a second configuration (e.g., an off or standby configuration, etc.), for example to restrict the flow of fire suppressant into the first zone. Further, the zone module 112 (e.g., via a feedback loop, automated control, etc.) may communicate a command to a delivery device in a second zone to operate in a third configuration (e.g., a discharge configuration, etc.), for example to provide the second zone with an amount of fire suppressant (e.g., a predetermined amount, for a predetermined amount of time, etc.). The zone module 112 may be configured to provide commands to one or more delivery devices associated with one or more zones (e.g., simultaneously, in sequence, in a pattern, for example an overlapping pattern, a sequential patterns, an escalating pattern, etc.), for example to selectively and/or individually control delivery of a fire suppressant agent to the one or more delivery devices (e.g., the one or more zones, etc.). Advantageously, the zone module 112 (e.g., via the nozzle interface 318, etc.) may facilitate monitoring multiple zones within an area, and offer selective and/or individual control/delivery of fire suppressant agent to one or more of the zones being monitored within the area, for example to prevent, mitigate, and/or extinguish a failure or potential thermal runaway event.

Referring still to FIG. 3, the zone module 112 is also shown to include a failure detector 320. In an implementation, the failure detector 320 is configured to receive one or more signals, and determine whether a potential failure or thermal runaway event, a fault, or hazardous condition (e.g., fire, likely fire, etc.) exists based on the signals. The failure detector 320 may be configured to receive one or more thermal signals, for example from the detector interface 314 (e.g., via the detector 134). As discussed above, the thermal signals may represent or be associated with one or more thermal characteristics measured at a detector (e.g., the detector 134). The failure detector 320 may also be configured to receive one or more zone identification signals, for example from zone identification interface 312. In this regard, in some implementations the failure detector 320 is also configured to associate one or more thermal signals with one or more zone identification signals, for example to associate a thermal characteristic with an appropriate (e.g., associated) zone. Further, in some implementations, the failure detector 320 is also configured to receive one or more actuator and/or nozzle configuration signals, for example from the zone actuator interface 316 and the nozzle interface 318. In this regard, in some implementations the failure detector 320 is configured to associate a plurality of signals (e.g., thermal, zone, actuator, nozzle, etc. signals), for example to associate thermal signals with a zone and the corresponding suppressant delivery devices (e.g., an actuator, nozzles, etc.) configured to service the zone.

The failure detector 320 can detect a failure and/or thermal runaway event (e.g., detect that the failure and/or runaway event is impending, is likely to occur, and/or exists), for example responsive to determining that the one or more thermal signals indicate that one or more threshold conditions exists. The failure detector 320 may be configured to determine that the one or more threshold conditions exist responsive to determining that the one or more signals from the detector interface 314 exceed one or more predetermined thresholds. The failure detector 320 can determine that the one or more threshold conditions exist responsive to determining that the one or more signals from the detector interface 314 (e.g., thermal signals) exceed a percentage (e.g., 50, 60, 75, 80, 85, 90, 95, etc. percent), or a predetermined value, of a predetermined threshold.

For example, the threshold condition can be a maximum measured thermal characteristic (e.g., temperature, thermal radiation, radiant heat, etc.), or a maximum average measured thermal characteristic within a zone (e.g., temperature, thermal radiation, radiant heat, etc.). In some implementations, the threshold condition is a maximum deviation in a measured thermal characteristic (e.g., temperature, radiation, heat, etc.). In other implementations, the threshold condition is a maximum rate of change of the measured thermal characteristic (e.g., rate of increase or decrease in temperature, thermal radiation, radiant heat, etc.). In yet other implementations, the threshold condition is a maximum number of devices or components within a zone that exceed a threshold thermal characteristic (e.g., temperature, thermal radiation, heat, etc.). As discussed above, it should be understood that in other implementations the threshold condition is associated with another suitable characteristic, for example, optical characteristics, gas emission, pressure, fluid flow, fluid levels, power output, power input, etc., or any combination thereof. In an implementation, the failure detector 320 determines a potential failure or thermal runaway event is present when one or more of the threshold conditions is satisfied.

As shown in FIG. 3, the zone module 112 is also shown to include a modulator 322. In an implementation, the modulator 322 is configured to receive one or more signals, and determine, based on the received one or more signals, that a level associated with a potential failure or thermal runaway event, a fault, or a hazardous condition (e.g., fire, likely fire, etc.). For example, the modulator 322 may be configured to receive a failure warning from the failure detector 320, indicating that a potential failure or thermal runaway event has been detected. Based on the signal, the modulator 322 may be configured to determine a level (e.g., severity level, etc.) associated with the detected failure or runaway event. In some implementations, the levels are based on a hierarchy, for example a hierarchy of the hazards associated with the detected event (e.g., less hazardous to more hazardous). For example, the modulator 322 may be configured to assign a first level to a failure warning that indicates that a potential failure has been detected in a zone that contains only a power converter, a second level to a failure warning that indicates that a potential failure has been detected in a zone that contains two operating device (e.g., two battery modules), a third level to a failure warning that indicates that a thermal runaway event has been detected in a zone that includes four operating devices (e.g., four battery modules), etc. In this regard, the modulator 322 may be configured to receive a signal indicating a potential failure or thermal runaway event has been detected, and based on the signal, assign a level indicating the level of hazardous conditions associated with the detected event.

The zone module 112 is further shown to include an association module 324. According to an implementation, the association module 324 is configured to receive one or more signals, and determine one or more associations between components and/or zones in the monitored area. For example, the association module 324 may be configured to receive a failure warning from the failure detector 320 (e.g., indicating a potential failure or thermal runaway event has been detected), and/or a modulation signal from the modulator 322 (e.g., indicating a modulated level associated with the detected event). Further, the association module 324 may be configured to receive one or more signals from the area identification interface 310 and/or the zone identification interface 312, for example indicating a configuration of the monitored area, one or more zones within the monitored area, and/or one or more components or devices within a zone. The configuration data (e.g., information) may indicate characteristics associated with the zones and/or components therein, for example location, proximity, orientation, device or component type, operating mode, connection points, connection components, etc. Based on the one or more signals, the association module 324 may be configured to determine associations between components or zones in the monitored areas, which may indicate an associated zone or component that may be at risk to experience a potential failure or thermal runaway event (e.g., based on the detected event). The association module 324 can store (e.g., in memory 116) the association (e.g., one or more flags or other data structures identifying the one or more zones and/or components corresponding to the association), which can allow various components of the zone module 112 to retrieve the association (e.g., using at least one first component of the association as a key) and identify the one or more zones and/or components according to the association.

For example, the association module 324 may determine no associations between a given zone and any other zone or components when a first level event is detected in the given zone (e.g., a potential runaway event in a zone that only contains a power converter). Conversely, the association module 324 may determine an association to one or more modules (e.g., modules that are coupled, a first module electrically coupled to a second module, modules that transfer power or electricity, etc.) when a second level event is detected in a zone (e.g., a potential runaway event is detected in one module within a zone). Further, the association module 324 may draw an association to zones located adjacent or proximate to (e.g., next to) a zone where a third level event is detected (e.g., a thermal runaway event has been detected in a zone that contains four operating devices, etc.). In this regard, the association module 324 may be configured to draw associations between components and/or zones in the monitored area, in order to identify potential components or zones that may be at risk of experiencing a potential failure or thermal runaway event based on their association (e.g., proximity, connection, etc.) with a detected event.

As shown in FIG. 3, the zone module 112 also includes a control decision generator 326. According to an implementation, the control decision generator 326 is configured to receive one or more signals, and generate/communicate one or more control decisions to prevent, mitigate, and/or eliminate a potential failure or thermal runaway event based at least on the received one or more signals. The control decision generator 326 may be configured to receive signals (e.g., information, data, instructions) from the failure detector 320, the modulator 322, and/or the association module 324. Based on the information, the control decision generator 326 may be configured to determine appropriate control decisions to address the potential failure or thermal runaway event, and/or communicate the control decisions to one or more components of the system 100, as discussed below.

As discussed herein, control decisions may include communications or indicators (e.g., alert, alarm, message, instruction, follow-up message, update, etc.), a control signal, command, or instruction (e.g., activation signal, response signal, deactivation signal, etc. to components of the system 100), an automated action signal or instruction (e.g., automatically implementing a safety measure, etc.), and/or any combination thereof. The control decisions may be general (e.g., generic automated safety actions, etc.), or specific to the detected event. For example, the control decisions may include a specific warning or instruction associated with the detected event, may include a specific sequence or timing (e.g., activation timing, deactivation timing, etc.) of control instructions based on the event, and/or may implement different automated actions in response to a detected event (e.g., partial system power-down, total system disconnect, etc.). In an implementation, the control decision generator 326 is configured to generate and/or communicate a plurality of control decisions, for example in sequence or at the same time. In some implementations, the control decision generator 326 is configured to generate and/or communicate control decisions in real time, for example to allow real time monitoring of conditions.

As an illustrative example, responsive to detecting a potential failure or thermal runaway event (e.g., at the failure detector 320), the control decision generator 326 may be configured to implement (e.g., generate, communicate, etc.) one or more control decisions. For example, the failure detector 320 may determine that a potential failure or thermal runaway event has been detected within an identified zone. Further, the modulator 322 may determine that the detected event is categorized as a level three potential failure or runaway event (e.g., based on the number/type of affected components). Yet further, the association module 324 may identify (e.g., associate) the other components within the zone, and a second (adjacent) zone as components/a zone that have an increased risk of experiencing a potential failure or thermal runaway event based on their association (e.g., proximity, connection, etc.) with the detected event. Based on this information, the control decision generator 326 may implement a first control decision (e.g., communicate an alert indicating that a failure or thermal runaway event has been detected in a zone) and a second control decision (e.g., actuate the actuator associated with the identified zone to deliver a fire suppressant agent to the zone). Further, the control decision generator 326 may implement a third control decision (e.g., actuate the actuator associated with the second zone at 50% to deliver a portion of a fire suppressant agent to the second zone), and/or a fourth control decision (e.g., communicate a message indicating that a second zone is being treated to prevent spread of the detected event).

In some implementations, if the characteristics of the detected failure or thermal runaway event drop below a threshold (e.g., as determined by the failure detector 320, the modulator 322, and/or the association module 324) such that the failure or runaway event is no longer detected, the control decision generator 326 may implement a fifth control decision (e.g., communicate a follow-up message indicating that the failure or runaway event is no longer detected). As discussed herein, a failure or thermal runaway event is no longer detected when the threshold thermal condition is no longer satisfied; however, in other implementations the failure or thermal runaway event may no longer be detected when the characteristic at the monitored area, a zone, and/or a component drop below a predetermined threshold (e.g., certain value, reduced percentage of the threshold condition, etc.). In yet other implementations, the zone module 112 (e.g., the control decision generator 326) is configured to deactivate the system 100 in response to a command from a user or operator, for example received from a remote device.

In some implementations, the control decision generator 326 is further configured to perform one or more safety actions, as indicated above. For example, the control decision generator 326 may be configured to implement an automated action to shut off an electrical connection (e.g., between modules), shut off a power support (e.g., to a zone), flip a breaker associated with a zone, etc. It should be understood that the control decision generator 326 may perform multiple safety actions at once, over a period of time, or otherwise, for example in response to a detected potential failure or thermal runaway event.

Referring now to FIG. 4, components of a fire suppression system 400 are shown as a configuration of the system 100, according to an implementation. The system 400 may include components that are substantially similar to the system 100 described herein, except as otherwise specified. For example, the zone module 112 of FIG. 4 may be the zone module 112 of FIGS. 1-3. In an implementation, the system 400 is included within a vehicle (e.g., an electric vehicle, a mining vehicle, a logging vehicle, etc.), and is configured to address one or more fires or potential thermal runaway events onboard the vehicle, as discussed below.

In an implementation, the system 400 is implemented within a suppression environment. For example, the suppression environment can be defined by one or more components of a power system or battery system, which may be an energy storage device, energy storage assembly, battery assembly, power source, or electrical energy source, or a battery pack 402 (not shown). In other implementations, the suppression environment is another component or area of a battery pack (e.g., a battery pack, a battery module, a sub-module, etc.) and/or another environment suitably configured for use with the fire suppression system 400 (e.g., a vehicle, a storage facility, a building, etc.).

As discussed herein, the system 400 may be integrated with or in communication with a power system or battery system, which may include an energy storage device, battery assembly, or the battery pack 402 (not shown). The battery pack 402 may be configured to store energy (e.g., chemically) and later discharge the stored energy as electrical energy to power one or more electrical loads (e.g., electric motors, resistive elements, lights, speakers, etc.). The battery pack 402 includes a series of battery portions or sections, shown as a subpack 404. Although only one subpack 404 is shown in FIG. 4, it should be understood that the battery pack 402 may include any suitable number of subpacks 404 (e.g., four, eight, etc.). Each subpack 404 further includes a series of battery portions or sections, shown as battery modules 406. Although 16 battery modules 406 are shown in FIG. 4, it should be understood that the subpack 404 may include any suitable number of battery modules 406 (e.g., 8, 10, 20, 24, 50, 100, etc.). Each battery module 406 includes a series of battery portions or sections, or battery cells 408 (not shown). Each battery module 406 may include hundreds of battery cells 408; however, in other implementations the battery modules 406 include another suitable number of battery cells 408. In an implementation, the battery cells 408 are lithium-ion (i.e., Li-ion) battery cells; however, in other implementations the battery cells 408 are cylindrical cells, prismatic cells, pouch cells, or another form factor of battery cells.

According to an implementation, each of the subpack 404, the battery modules 406, and/or the battery cells 408 may be configured to store a portion of the stored energy of the battery pack 402. For example, the battery cells 408, the battery modules 406, and/or the subpacks 404 may be arranged in series/parallel to control the output voltage of the battery pack 402 at ab electrical port and the capacity of the battery pack 402 at that output voltage. In some implementations, the battery pack 402 and/or components thereof (e.g., the subpack 404, the battery modules 406, etc.) is/are coupled to one or more power or output stops, shown as one or more disconnects 410. In an implementation, the disconnects 410 are configured to limit or restrict power or electrical energy from flowing into/out of the battery pack 402 (e.g., the battery modules 406), for example to prevent a power surge or power draw to/from the battery pack 402 (e.g., during a potential failure or thermal runaway event).

As shown in FIG. 4, the battery pack 402 (e.g., the subpack 404) further includes one or more detectors 134, one or more valves 136, and one or more nozzles 138. As discussed above, the detectors 134 may be configured to communicate with the zone module 112, for example to provide data relating to the thermal characteristics of one or more components of the battery pack 402 (e.g., the subpack 404), which may be used to detect a potential failure or thermal runaway event. The valves 136 may also be configured to communicate with the zone module 112, for example to receive control decisions to facilitate delivery of a fire suppressant agent to associated nozzles 138 and/or zones. In some implementations, the nozzles 138 are configured to selectively delivery the fire suppressant agent to a targeted area or component (e.g., a battery module 406, or plurality of battery modules 406). As will be discussed in greater detail below, in an implementation each detector 134 is configured to detect thermal characteristics of a specified area or zone, and each area or zone has an associated valve 136 configured to deliver a fire suppressant agent to the nozzles 138 within the zone to address a potential fire or thermal runaway event therein (e.g., the battery modules 406 therein, etc.).

In an implementation, the battery pack 402 (e.g., the subpack 404) includes a manifold 412. As shown, the manifold 412 is communicably coupled (e.g., fluidly, etc.) to the valves 136 and/or the suppressant output system 122. According to an implementation, the manifold 412 is configured to receive a fire suppressant agent from the suppressant output system 122 (e.g., via the container 126, etc.), and is configured to direct (e.g., communicate, move, distribute, etc.) the fire suppressant agent to the one or more valves 136. The manifold 412 may be configured to uniformly distribute the fire suppressant agent to the one or more valves 136. However, in other implementations the manifold 412 (e.g., via one or more valves, pumps, etc.) is configured to receive a control decision (e.g., via the zone module 112) and control delivery of the fire suppressant agent to the one or more valves 136 (e.g., and the associated nozzles 138).

Referring still to FIG. 4, the suppression environment of the system 400 is shown to include a monitored area, shown as monitored area 420. According to an implementation, the monitored area 420 is an area to be monitored by the fire suppression system 400, for example to prevent, mitigate, and/or extinguish a fire or thermal runaway event within the monitored area 420. In an implementation, the monitored area 420 is defined by the subpack 404 (e.g., an internal volume defined by a housing of the subpack 404). The monitored area 420 may be determined, defined, and/or identified, for example based on hardcoded rules or configuration data (e.g., from the fire suppression controller 102, the related system 180, etc.) and/or an input provided via a user device (e.g., a configuration profile provided via the user interface 154). For example, the zone module 112 (e.g., via the area identification interface 310) may be configured to determine, define, and/or identify the monitored area 420 based on one or more inputs from components of the system 400. In other implementations, the monitored area 420 is another suitable area suitable to interact with the suppression system 400 (e.g., a component of the battery pack 402, a storage facility, a component of a vehicle, etc.).

As shown, the monitored area 420 can be divided into one or more monitored areas or zones, shown as zones 422, 424, 426, and 428. In an implementation, the monitored area 420 includes four zones (e.g., 422, 424, 426, and 428). Each zone 422-428 may be determined, defined, and/or identified, for example based on hardcoded rules or configuration data (e.g., from the fire suppression controller 102, the related system 180, etc.) and/or an input provided via a user device (e.g., a configuration profile provided via the user interface 154). For example, the zone module 112 (e.g., via the zone identification interface 312) may be configured to determine, define, and/or identify the zones 222-228 within the monitored area 420 based on one or more inputs from components of the system 400. As discussed above, in an implementation the zone module 112 is further configured to identify and/or determined one or more components, devices, and/or configurations associated with each of the zones 422-428. For example, the zone module 112 may determine that each of zones 422-428 includes a detector 134, an associated valve 136, a plurality of battery modules 406, and nozzles 138 associated with each of the battery modules 406. It should be understood that while the monitored area 420 is shown to include four zones (e.g., zones 422-428) having components described herein, it is contemplated that the monitored area 420 includes another suitable number of zones (e.g., 2, 6, 12, 18, etc.) having additional, fewer, and/or different working components.

As will be discussed in greater detail below, in an implementation the detector 134 of each of the zones 422-428 is configured to communicate one or more characteristics (e.g., one or more thermal signals, thermal characteristics, etc.) of each respective zone to the zone module 112 (e.g., via the detector interface 314). The zone module 112 (e.g., the failure detector 320) may be configured to determine if a failure or thermal runaway event is impending, is likely to occur, and/or exists, for example based on whether one or more threshold conditions exists. In some implementations, the zone module 112 (e.g., the modulator 322) is configured to modulate the one or more signals to determine a level associated with the potential failure or thermal runaway event, and/or (e.g., the association module 324) is configured determine one or more associations between zones 222-228 (or components therein) in the monitored area 420. According to an implementation, in response to determining that a potential failure or thermal runaway event has been detected, the zone module 112 (e.g., the control decision generator 326) may be configured to generate and communicate one or more control decisions to prevent, mitigate, and/or eliminate a potential failure or thermal runaway event. For example, the zone module 112 may determine a potential failure has been detected in zone 422 (e.g., via signals from the detector 134) and communicate a command to actuate the valve 136 associated with the zone 422 into an open configuration, thereby allowing a fire suppressant agent to be delivered to the zone 422 (e.g., and components therein). In some implementations, the zone module 112 is configured to communicate one or more commands to components associated with one or more zones (e.g., to valves 136 associated with zones 422-428, etc.), for example to selectively control configurations of the components (e.g., an open configuration, a closed configuration, a standby configuration, a high/low-flow configuration, etc.) in order to selectively control the delivery of a fire suppressant agent to the zones (e.g., and components therein).

### Configurations and Method of Operation

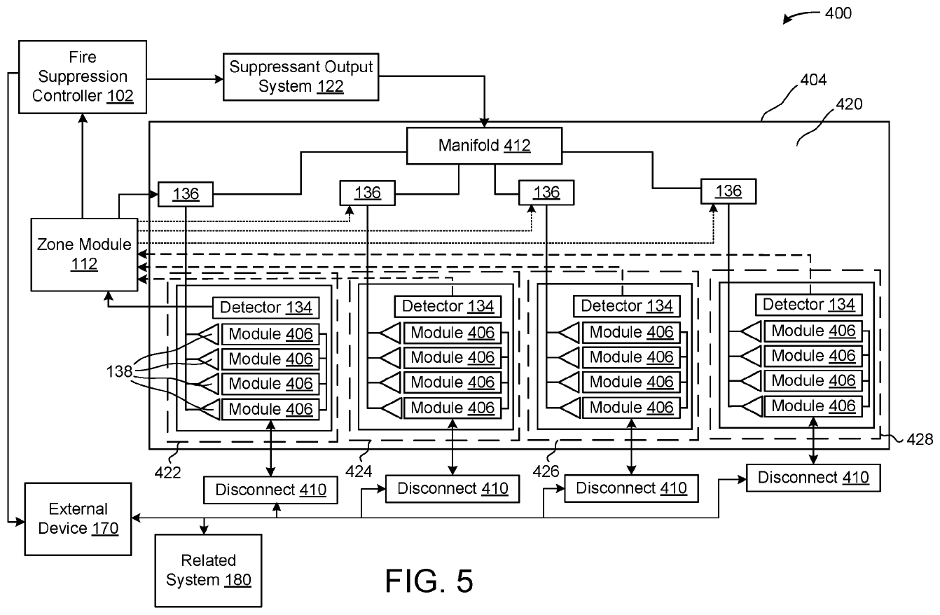

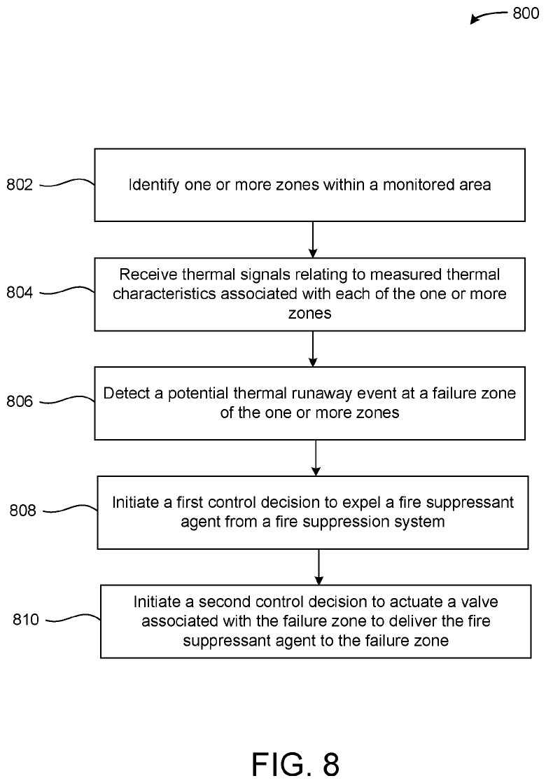

Referring generally to FIGS. 5-8, various configurations and methods of operating a fire detection, prevention, mitigation, and/or suppression system is shown, according to some implementations. For example, the configurations of FIGS. 5-7 can be implemented using the components of the FIGS. 1-4, and the process 800 of FIG. 8 can be implemented using the components of FIGS. 1-4. According to an implementation, the operating configurations and methods of FIGS. 5-8 are configured to monitor one or more zones within a monitored area, determine the presence of a fire or potential thermal runaway event within one or more of the monitored zones, and/or control the delivery of a fire suppressant to one or more of the monitored zones to prevent, mitigate, and/or extinguish a fire or thermal runaway event. In some implementations, the configurations of FIGS. 5-7 and/or the process 800 of FIG. 8 can be performed by a module (e.g., the zone module 112), and/or any various components of a fire suppression system.

According to an implementation, one or more zones in a monitored area are identified (step 802). For example, the zone module 112 (e.g., the zone identification interface 312) may be configured to receive one or more inputs (e.g., data, configuration layouts, rules, etc.), and may determine (e.g., identify, etc.) one or more zones to be monitored within a monitored area. In an implementation, the monitored area is a subpack of a battery (e.g., the subpack 404); however, in other implementations the monitored area is another suitable environment (e.g., a battery pack, a vehicle compartment, a building, a storage facility, etc.). As shown in FIG. 4, in an implementation the monitored area includes four zones, zones 422-428. In some implementations, the zone module 112 (e.g., the zone identification interface 312) is further configured to receive one or more inputs (e.g., data, configuration layouts, rules, etc.), and determine (e.g., identify) one or more components, devices, and/or configurations associated with each zone. For example, and as shown in FIG. 4, each zone may include a detector 134, an associated valve 136, a plurality of (e.g., four, etc.) battery modules 406, and nozzles 138 associated with each of the battery modules 406. According to an implementation, the inputs are received and/or provided by the fire suppression controller 102 (e.g., via hardcoded rules or configuration data, etc.), the user interface 154 (e.g., via a configuration profile, etc.), the related system 180 (e.g., via hardcoded system configurations or rules), and/or another suitable component of the fire suppression system.

In an implementation, thermal signals from a detector associated with each of the one or more identified zones is received (step 804). For example, as shown in FIG. 4 the zone module 112 (e.g., the detector interface 314) may be configured to receive one or more input signals (e.g., data, commands, etc.) measured at each of the detectors 134 of the zones 422-428. The input signals may relate to one or more thermal characteristics of a component or device within each of the zones 222-228, or the zones 422-428 as a whole. For example, the thermal signals may relate to radiant heat, thermal radiation, temperature, etc. of the zones 422-428 or the components therein (e.g., the battery modules 406, etc.). As discussed above, in other implementations the signals relate to one or more other characteristics associated with the zones 422-428 or components therein, for example optical characteristics, gas emission, pressure, fluid flow, fluid levels, power output, power input, etc., or any combination thereof.

According to an implementation, the system is configured to detect, based on the thermal signals, a potential failure or thermal runaway event at a failure zone of the one or more identified zones (step 806). For example, the zone module 112 (e.g., the failure detector 320) may receive the thermal signals from each of the detectors 134 associated with the zones 422-428, and may be configured to detect (e.g., determine, identify, etc.) whether a potential failure or thermal runaway event, a fault, or hazardous condition (e.g., fire, likely fire, etc.) exists based on the signals. As discussed above, the zone module 112 (e.g., failure detector 320) may be configured to determine a failure or thermal runaway event is impending, is likely to occur, and/or exists, for example based on whether the signals (e.g., from the detectors 134) from one of the one or more identified zones 422-428 satisfy a threshold condition (e.g., exceed a threshold condition, etc.). For example, the threshold condition may be satisfied at a failure zone based on a maximum measured thermal characteristic, a maximum average measured thermal characteristic within a zone, a maximum deviation in a measured thermal characteristic, a maximum rate of change of the measured thermal characteristic, if a maximum number of devices or components within a zone that exceed a threshold thermal characteristic, and/or any other suitable threshold condition.

In an implementation, based on the detected failure or thermal runaway event at the failure zone, a component of a suppression system is configured to be activated (step 808). For example, in response to detecting (e.g., determining, identifying, etc.) a potential failure or thermal runaway event at one of the zones 422-428 (e.g., the failure zone), the zone module 112 (e.g., control decision generator 326) may be configured to activate a component of the suppressant output system 122 and/or the suppression system 200. In an implementation, the zone module 112 is configured to communicate with the fire suppression controller 102 (e.g., one or more commands, etc.), for example to initiate automated delivery of a chemical agent from the suppressant output system 122 (e.g., the container 126) and/or the system 200 (e.g., the container 226), as discussed above. For example, the zone module 112 may communicate one or more commands (e.g., via the fire suppression controller 102) to activate the actuator 128 (or 228), thereby releasing a pressurized gas from the cartridge 124 (or 224) to pressurize the container 126 (or the container 226), which may facilitate delivery (e.g., via a conduit, tube, etc.) of a fire suppressant agent to one or more components of the system (e.g., the manifold 412). In other implementations, the zone module 112 may communicate one or more instructions or communications to a user device or related system (e.g., user interface 154, related system 180, etc.), for example to provide a warning or instruction to a user to initiate manual operation of the suppressant output system 122 and/or components of the system 200.

According to an implementation, based on the detected failure or thermal runaway event at the failure zone, a valve associated with the failure zone is configured to be activated to facilitate delivery of a fire suppressant agent to the failure zone (step 810). As shown in FIG. 4, each of the valves 136 associated with the zones 422-428 is in communication (e.g., fluid communication) with the manifold 412. As discussed above, based on a detected failure or thermal runaway event at one of the zones 422-428 (e.g., a failure zone), the manifold 412 is configured to receive a fire suppressant agent from a component of the suppressant output system 122 and/or the system 200. According to an implementation, the zone module 112 (e.g., the zone actuator interface 316) is configured to communicate one or more control decisions (e.g., commands, instructions, etc.) to activate a valve 136 associated with the failure zone (e.g., one of the zones 422-428 where the failure was detected), for example to facilitate delivery of the fires suppressant agent from the manifold 412 (through the valve 136) and to the failure zone (e.g., the zone where a thermal runaway even has been detected). As discussed above, the control decision (e.g., command, instruction, etc.) may control one or more characteristics of the valve 136 and/or the fire suppressant agent that moves through the valve 136. For example, the control decision may change a configuration of the valve 136 (e.g., to an open configuration), a timing of the configuration of the valve 136 (e.g., open for a predetermined period of time, then closed, etc.), and/or a characteristic of the fire suppressant agent that is delivered from the valve 136 (e.g., a flow, volume, speed, pressure, direction, etc.). In this regard, the zone module 112 may be configured to selectively activate the valve 136 associated with a failure zone, for example to provide targeted delivery of a fire suppressant agent to an area where a failure or potential thermal runaway event has been detected.

As an illustrative example, and as shown in FIGS. 4-5, a plurality of zones (e.g., zones 422-428) can be identified in a monitored area (e.g., the subpack 404). Each of the zones may include various components, devices, and/or configurations, for example a detector 134, a valve 136 associated with each zone, a plurality of battery modules 406, and nozzles 138. As shown in FIG. 4, the zone module 112 is configured to receive signals from the detectors of each of the zones 422-428, for example thermal signals relating to one or more thermal characteristics of the zones 422-428 or components therein (e.g., radiant heat, thermal radiation, temperature, etc.). Based on the signals, the zone module 112 may be configured to detect (e.g., determine, identify, etc.) a potential failure or thermal runaway event at one or more zones (e.g., a failure zone) of the identified zones 422-428. For example, as illustrated in FIG. 5, the zone module 112 may detect (e.g., determine, identify, etc.) a potential failure or thermal runaway event at zone 422, for example based on the signals exceeding or satisfying a threshold condition. In response to the detected failure or runaway event at zone 422, the zone module 112 may activate one or more components of the suppressant output system 122 (e.g., and/or the system 200), for example to initiate delivery of a fire suppressant agent to the manifold 412. Further, based on the detected failure or runaway event at the zone 422, the zone module 112 may communicate a control decision (e.g., instruction, command, etc.) to the valve 136 associated with the zone 422 (as shown in FIG. 5). The control decision may activate or actuate the valve 136 associated with zone 422, for example to facilitate delivery of the fire suppressant agent (e.g., from the manifold 412) through the valve 136, and to the nozzles 138 within the zone 422. The targeted delivery of the fire suppressant agent from the nozzles 138 within the zone 422 may be configured to prevent, mitigate, and/or extinguish a potential failure or thermal runaway event at the zone 422 and/or components therein (e.g., the battery modules 406).

According to some implementations, based on the detected failure or thermal runaway event at the failure zone, the system is also configured to determine a level associated with the potential failure or thermal runaway event. In some implementations, this occurs after step 808 and/or before step 810. For example, in response to detecting a failure or thermal runaway event at the failure zone, the zone module 112 (e.g., the modulator 322) may be configured to (e.g., based on the detected signals) determine a level (e.g., severity level, etc.) associated with the detected failure or runaway event. As discussed above, in some implementations the determined levels are based on a hierarchy of the hazards associated with the detected event (e.g., less hazardous to more hazardous).

In other implementations, based on the detected failure or thermal runaway event at the failure zone, the system is also configured to determine one or more associations between components and/or zones in the monitored area. In some implementations, this occurs after step 808 and/or before step 810. For example, in response to detecting a failure or thermal runaway event at the failure zone, the zone module 112 (e.g., the association module 324) may be configured to (e.g., based on the detected signals) determine associations between zones (e.g., the zones 422-428) and/or components therein in the monitored areas. As discussed above, the associations may indicate an associated zone or component that may be at risk to experience a potential failure or thermal runaway event (e.g., based on the detected event). In some implementations, the zone module 112 (e.g., the modulator 322, the association module 324) is configured to determine both a level associated with the detected failure or event and one or more associations between the detected failure or event and associated zones or components (e.g., level then associations, associations then levels, etc.).

As an illustrative example, and as shown in FIGS. 4-7, a plurality of zones (e.g., zones 422-428) can be identified in a monitored area (e.g., the subpack 404), each of the zones having various components (e.g., a detector 134, a valve 136, battery modules 406, nozzles 138, etc.), as discussed above. As shown in FIG. 4, the zone module 112 is configured to receive signals from the detectors 134 of each of the zones 422-428, and based on the signals the zone module 112 may detect a potential failure or thermal runaway event at one or more of the zones (e.g., a failure zone). For example, as illustrated in FIG. 5, the zone module 112 may detect (e.g., determine, identify, etc.) a potential failure or thermal runaway event at zone 422, for example based on the signals at the zone 422 exceeding or satisfying a threshold condition. As discussed above, in response to the detected failure or runaway event at the zone 422, the zone module 112 may activate the suppressant output system 122 (e.g., and/or the system 200), for example to initiate delivery of a fire suppressant agent to the manifold 412.

According to an implementation, based on the signals (e.g., at the zone 422, the zones 422-428, etc.) the zone module 112 is also configured to determine a level associated with the detected failure or runaway event. Further, based on the signals (e.g., at the zone 422, the zones 422-428, etc.) the zone module 112 may also be configured to determine one or more associations between components and/or zones associated with the failure zone (e.g., components of the zone 422, the zones 424-428 and components thereof, etc.). Based on the detected failure or runaway event at the zone 422, as well as the determined level of the detected event and/or the one or more determined associations between the detected event and additional components, the zone module 112 is configured to communicate one or more control decisions to facilitate delivery of a fire suppressant agent to prevent, mitigate, and/or extinguish the detected event.

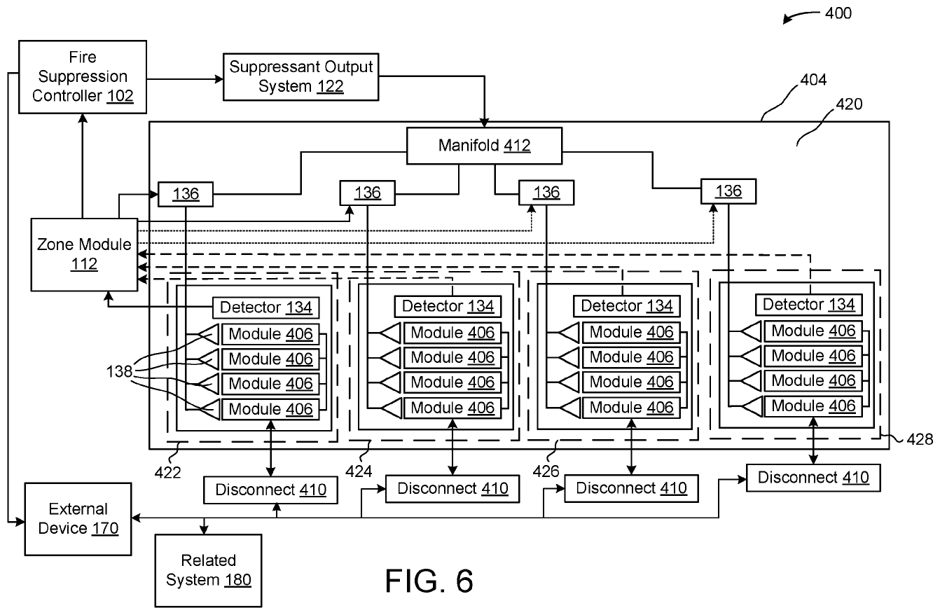

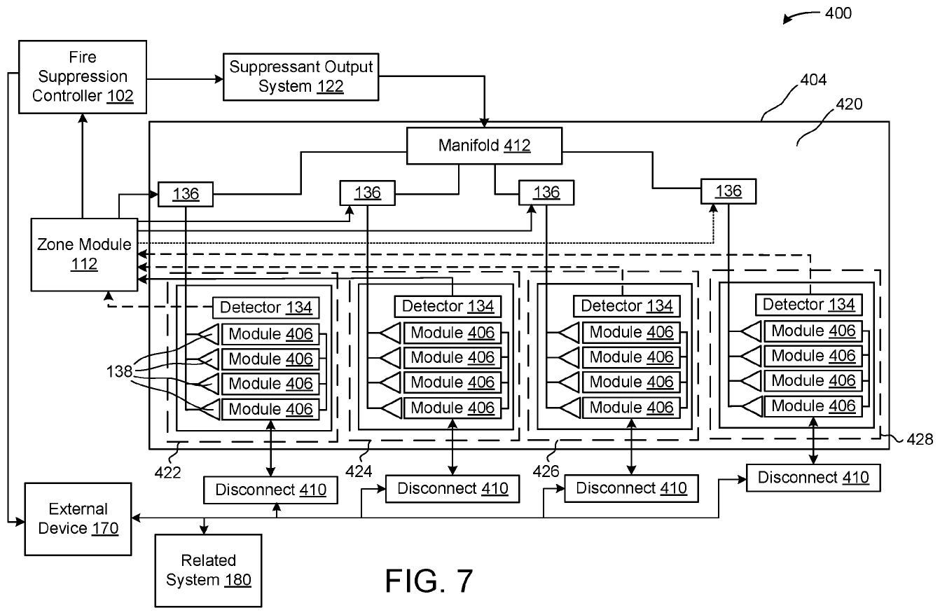

For example, the zone module 112 may detect a potential failure or thermal runaway event in the zone 422, as shown in FIG. 5 and as discussed above. In the implementation shown in FIG. 5, the zone module 112 may determine that the detected event is categorized as a level one failure event, with no associations to other components or zones. Based on this, the zone module 112 may generate and/or communicate a control decision to activate the valve 136 associated with the zone 422, to facilitate delivery of the fire suppressant agent to components of the zone 422 (e.g., at a first, high-flow, configuration, and a second, low-flow, configuration; at sequential release configurations; at timed release configurations, etc.). However, the in implementation shown in FIG. 6, the zone module 112 may determine that the detected event is categorized as a level two failure event, with an association with components of the zone 424. Based on this, the zone module 112 may generate and/or communicate control decisions to activate the valve 136 associated with the zone 422 and the valve 136 associated with the zone 424. In some implementations, the zone module 112 is configured to generate and/or communicate control decisions to deactivate the valve 136 associated with the zone 422 (e.g., after a predetermined amount of time, after a predetermined amount of fire suppressant is released, etc.). In this regard, the zone module 112 may be configured to implement a series of control decisions so as to mitigate or prevent potential spread of a failure or runaway event. Yet further, in the implementation shown in FIG. 7, the zone module 112 may determine that the detected potential failure or thermal runaway event (e.g., in zone 422) has dropped below a threshold such that the failure or thermal runaway event is no longer detected. However, the zone module 112 may detect a potential failure or thermal runway event in another zone (e.g., the zone 424). Given the spread of the event, the zone module 112 may determine that the detected event is categorized as a level three failure event, with associations to the surrounding zones (e.g., zone 422, zone 426, etc.). Based on this, the zone module 112 may generate and/or communicate a series of control decisions to activate the valves 136 associated with zones 422, 424, and 426, respectively (e.g., sequentially, at timed or predetermined intervals, in overlapping or other patterns, etc.), to provide a fire suppressant agent to the zones 422-426 to prevent, mitigate, and/or extinguish the fire or thermal runaway event.

It should be understood that while components of the systems (e.g., the zone module 112) described herein are described as having certain functions and/or configurations, additional or different functions and/or configurations are contemplated. As an example, the zone module 112 may be configured to communicate the one or more control decisions described herein to additional components of the systems to facilitate delivery of a fire suppressant agent. For example, the zone module 112 may communicate one or more control decisions to the fire suppression controller 102, and the fire suppression controller 102 may initiate an automated action to control a valve or actuator to deliver a fire suppressant agent. Further, the zone module 112 may communicate one or more control decisions to a nozzle (e.g., the nozzle 138) and/or a manifold (e.g., the manifold 412), for example to control delivery of a fire suppressant agent (e.g., to a zone). The zone module 112 may also communicate a control decision to the related system 180 (e.g., a vehicle, storage facility, building, etc.), for example to initiate a safety response, power off or shut down certain components of the related system 180 etc. In addition, the zone module 112 may communicate a control decision (e.g., instruction, message, alert, etc.) to the external device 170 (e.g., a building management system, etc.) and/or the user interface 154 (e.g., user device), for example to provide an indication or an alert associated with a potential failure and/or response action. As such, while the components of the systems described herein are described as performing certain actions and/or having certain functions, these are to be understood as exemplary and non-limiting.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various implementations, are intended to indicate that such implementations are possible examples, representations, or illustrations of possible implementations (and such terms are not intended to connote that such implementations are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other implementations, and that such variations are intended to be encompassed by the present disclosure.

The hardware and data processing components used to implement the various processes, operations, illustrative logics, logical blocks, modules and circuits described in connection with the implementations disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an implementation, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 100 as shown in the various implementations is illustrative only. Additionally, any element disclosed in one implementation may be incorporated or utilized with any other implementation disclosed herein. For example, the system 200 the implementation shown in at least FIG. 2 may be incorporated in the system 100 of the implementation shown in at least FIG. 1. Although only one example of an element from one implementation that can be incorporated or utilized in another implementation has been described above, it should be appreciated that other elements of the various implementations may be incorporated or utilized with any of the other implementations disclosed herein.

What is claimed is:

1. A system, comprising:
a fire suppression system having a supply configured to house a fire suppressant agent, the fire suppression system configured to selectively provide the fire suppressant agent to one or more components within a monitored area;
a zone module in communication with the fire suppression system, the zone module having one or more processors and a memory storing instructions that, when executed by the one or more processors, cause the one or more processors to perform operations comprising:
identifying one or more zones within the monitored area;
receiving, from detectors associated with each of the one or more zones within the monitored area, signals relating to one or more measured thermal characteristics associated with each of the one or more zones;
detecting, based on the signals, a potential thermal runaway event at a failure zone, the failure zone being one of the one or more zones within the monitored area;
initiating, in response to detecting the potential thermal runaway event, a first control decision to expel the fire suppressant agent from the supply; and
initiating, based on detecting the potential thermal runaway event at the failure zone, a second control decision to actuate a valve associated with the failure zone to deliver the fire suppressant agent to the failure zone.

2. The system of claim 1, wherein the operations further comprise:
determining, based on the signals, a level associated with the potential thermal runaway event at the failure zone, wherein the level indicates a hazard level associated with the potential thermal runaway event.

3. The system of claim 2, wherein the operations further comprise:
determining, based on the signals, one or more associations between the failure zone and a component or zone of the one or more zones within the monitored area.

4. The system of claim 3, wherein the operations further comprise:
initiating, based on the determined level associated with the potential thermal runaway event and the one or more associations, a third control decision to actuate another valve associated with another zone to deliver the fire suppressant agent to the other zone.

5. The system of claim 1, wherein the monitored area is a subpack of a battery pack.

6. The system of claim 1, wherein each of the one or more zones includes a plurality of battery modules positioned within each of the one or more zones.

7. The system of claim 1, wherein detecting the potential thermal runaway event includes determining at least one of: (i) an average of the one or more measured thermal characteristics over a period of time exceeds a predetermined threshold average of the one or more measured thermal characteristics over a period of time, (ii) a predetermined number of the one or more measured thermal characteristics exceeds a predetermined threshold of the thermal characteristic, or (iii) determining a rate of change of the one or more measured thermal characteristics over a period of time exceeds a predetermined threshold rate of change from the one or more measured thermal characteristics over the period of time.

8. The system of claim 1, wherein at least one of the first or second control decisions further includes an indication to a computing device, the indication including a warning message and an instruction to mitigate the potential thermal runaway event.

9. The system of claim 1, wherein initiating the first control decision includes activating a puncturing pin to puncture a rupture disc of a cartridge of the fire suppression system, wherein, in response to puncturing the rupture disc, the cartridge is configured to communicate a pressurized expellant gas to the supply to pressurize a container and expel the fire suppressant agent from the container.

10. The system of claim 1, further comprising a manifold in fluid communication with the supply and a plurality of valves, wherein the valve associated with the failure zone is one valve of the plurality of valves, and wherein initiating the second control decision includes actuating the valve associated with the failure zone to an open configuration.

11. A control circuit, comprising:
one or more processors and a memory storing instructions that, when executed by the one or more processors, cause the one or more processors to perform operations comprising:
identifying one or more zones within a monitored area;
receiving, from detectors associated with each of the one or more zones within the monitored area, signals relating to one or more measured thermal characteristics associated with each of the one or more zones;
detecting, based on the signals, a potential thermal runaway event at a failure zone, the failure zone being one of the one or more zones within the monitored area;
initiating, in response to detecting the potential thermal runaway event, a first control decision to expel a fire suppressant agent; and
initiating, based on detecting the potential thermal runaway event at the failure zone, a second control decision to actuate a valve associated with the failure zone to deliver the fire suppressant agent to the failure zone.

12. The control circuit of claim 11, wherein the operations further comprise:
determining, based on the signals, a level associated with the potential thermal runaway event at the failure zone, wherein the level indicates a hazard level associated with the potential thermal runaway event.

13. The control circuit of claim 12, wherein the operations further comprise:
determining, based on the signals, one or more associations between the failure zone and a component or zone of the one or more zones within the monitored area.

14. The control circuit of claim 13, wherein the operations further comprise:
initiating, based on the determined level associated with the potential thermal runaway event and the one or more associations, a third control decision to actuate another valve associated with another zone to deliver the fire suppressant agent to the other zone.

15. The control circuit of claim 11, wherein the monitored area is a subpack of a battery pack.

16. A method for detecting and mitigating a potential thermal runaway event, the method comprising:
identifying one or more zones within a monitored area;
receiving, from detectors associated with each of the one or more zones within the monitored area, signals relating to one or more measured thermal characteristics associated with each of the one or more zones;
detecting, based on the signals, the potential thermal runaway event at a failure zone, the failure zone being one of the one or more zones within the monitored area;
initiating, in response to detecting the potential thermal runaway event, a first control decision to expel a fire suppressant agent; and
initiating, based on detecting the potential thermal runaway event at the failure zone, a second control decision to actuate a valve associated with the failure zone to deliver the fire suppressant agent to the failure zone.

17. The method of claim 16, further comprising:
determining, based on the signals, a level associated with the potential thermal runaway event at the failure zone, wherein the level indicates a hazard level associated with the potential thermal runaway event.

18. The method of claim 17, further comprising:
determining, based on the signals, one or more associations between the failure zone and a component or zone of the one or more zones within the monitored area.

19. The method of claim 18, further comprising:
initiating, based on the determined level associated with the potential thermal runaway event and the one or more associations, a third control decision to actuate another valve associated with another zone to deliver the fire suppressant agent to the other zone.

20. The method of claim 16, wherein identifying the one or more zones within the monitored area includes identifying the one or more zones within a subpack of a battery pack.
